(19) United States
(12) Patent Application Publication
(10) Pub. No.: US 2008/0168554 A1
(43) Pub. Date: Jul. 10, 2008

(54) IMAGE FORMING APPARATUS AND METHOD OF OUTPUTTING

(75) Inventor: Haeng Nan KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/971,356

(22) Filed: Jan. 9, 2008

(30) Foreign Application Priority Data
Jan. 10, 2007 (KR) 2007-2949
Dec. 24, 2007 (KR) 2007-136010

(51) Int. Cl. H04L 9/32; H04L 9/06

(52) U.S. Cl. 726/18; 380/243

(57) ABSTRACT

An image forming apparatus capable of printing encrypted PDF and XPS files through a direct printing scheme even if the image forming apparatus has no user interface or control panel, and a method of outputting document using the same. The method includes determining whether a document subject to a direct printing is an encrypted document; receiving a password from a host if the document is encrypted; comparing the password with a reference password of the document and determining whether the password matches the reference password; and performing a printing operation for the document according to the determination result if the document is encrypted.

### CROSS-REFERENCE TO RELATED APPLICATIONS

This application claims the benefit of Korean Patent Application No. 2007-2949, filed Jan. 10, 2007 and Korean Patent Application No. 2007-136010 filed Dec. 24, 2007 in the Korean Intellectual Property Office, the disclosures of which are incorporated herein by reference.

### BACKGROUND OF THE INVENTION

1. Field of the Invention

Aspects of the present invention relate generally to an image forming apparatus and a method of outputting a document using the same and more particularly, aspects of the present invention relate to an image forming apparatus capable of printing an encrypted document through a direct printing scheme and a method of outputting the document using the same.

2. Description of the Related Art

In general, an image forming apparatus refers to an apparatus that outputs data on a printing medium. For example, an image forming apparatus may be a printer, a scanner, a photocopier, a facsimile, or a multifunctional device. As the performance of the image forming apparatus has advanced, an image forming apparatus capable of directly printing data is developed.

The image forming apparatus supports a direct printing function for PDF, TIFF, JPEG, XPS, and BMP files. This direct printing function directly performs a printing operation by receiving files that have been transmitted from a host without executing an additional application program using the host. A host may be a digital camera, a PDA, a notebook computer, or the like.

The direct printing function is suitable for PDF, TIFF, JPEG, XPS, and BMP files. In the case of the PDF and XPS files, it is possible to encrypt the document when preparing the document.

However, conventionally, if an encrypted file is sent to the image forming apparatus equipped with the direct printing function, an error message informing a user that the sent document is an encrypted file is output and the printing is canceled.

Further, in the case of an image forming apparatus having no user interface, such as having no LCD display and/or keypad, the user cannot input the password for the document even if the user knows the password rendering the printing of an encrypted file is impossible.

### SUMMARY OF THE INVENTION

Accordingly, it is an aspect of the present invention to provide an image forming apparatus capable of printing an encrypted document through a direct printing and a method of outputting the document using the image forming apparatus.

Another aspect of the present invention is to provide an image forming apparatus capable of printing an encrypted document by allowing a user to input a password even if the image forming apparatus has no user interface, such as an LCD and/or a keypad, and a method of outputting the document using the image forming apparatus.

Additional aspects and/or advantages of the invention will be set forth in part in the description, which follows and, in part, will be apparent from the description, or may be learned by practice of the invention.

According to an aspect of the present invention, a method of outputting a document using an image forming apparatus having no user interface for inputting a password is provided, the method includes receiving a document subject to a direct printing and determining whether the document is encrypted; receiving a password from a host if the document is encrypted; comparing the password with a reference password of the document and determining whether the password matches the reference password; and performing a printing operation for the document according to the determination result if the document is determined to be encrypted.

According to an aspect of the present invention, the document may be a PDF file or an XPS file.

According to an aspect of the present invention, the document is an encrypted document input from the host or a portable storage medium for a direct printing.

According to an aspect of the present invention, the receiving of the password from the host includes determining whether the password is input within a predetermined time; and displaying a warning message if the password is not input within the predetermined time.

According to an aspect of the present invention, the method may further include displaying a warning message if the password is not identical to the reference password.

In another aspect, aspects of the present invention provide an image forming apparatus having no user interface for inputting a password, the image forming apparatus including: a controller to receive a document subject to a direct printing, to determine whether the received document is encrypted, and to receive a password from a host if the document is encrypted; and a printing unit to print the document, wherein the controller compares the password with a reference password of the document and controls the printing unit to print the document when the password matches with the reference password if the document is encrypted.

According to an aspect of the present invention, the controller requests the host to display a warning message when the password does not match the reference password.

According to an aspect of the present invention, the controller counts an input time for the password and requests the host to display a warning message when the password is not input within a predetermined period of time.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a configuration of an image forming apparatus equipped with a direct printing function to print an encrypted document according to an embodiment of the present invention;

FIG. 2 is a view illustrating a password input window to allow a user to input a password according to aspects of the present invention;

FIG. 3 is a view illustrating a printing window to print document data according to aspects of the present invention;

FIG. 4 is a view illustrating a window that displays a result of password identification according to aspects of the present invention; and

FIG. 5 is a flowchart illustrating the procedure to output a document using an image forming apparatus according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

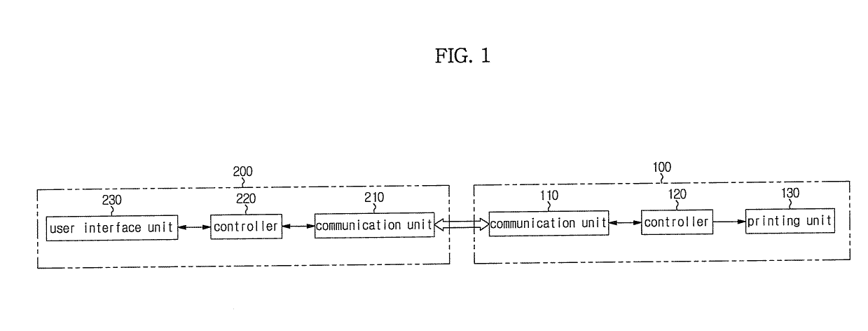

FIG. 1 is a block diagram illustrating a configuration of an image forming apparatus 100 equipped with a direct printing function for printing an encrypted document according to an embodiment of the present invention. The image forming apparatus 100 includes a communication unit 110, a controller 120, and a printing unit 130. The image forming apparatus 100 is connected to a host 200 through the communication unit 110.

The communication unit 110 is connected to the host 200 (such as a digital camera, a PDA, a PC, or a notebook computer) through a network to provide a communication interface relative to the host 200. The host 200 need not be hard-wired to the image forming apparatus 100; but instead, the host 200 may exchange data and information, securely or not, with the image forming apparatus 100 via IR, Wi-Fi, Bluetooth, or the like in addition to or instead of any wire connection. Further, the network between the image forming apparatus 100 and the host 200 may only include the image forming apparatus 100 and the host 200 or may include other hosts, computer terminals, or any other network element.

The controller 120 receives a document from the host 200 through the communication unit 110 and determines whether the document is an encrypted document. The controller 120 controls the image forming apparatus 100 according to the determination result such that the image forming apparatus 100 can receive a password for the document from the host 200. That is, if the document is an encrypted document, the controller 120 controls the image forming apparatus 100 to receive the password for the document from the host 200 even if the image forming apparatus 100 is not equipped with a user interface, i.e., the image forming apparatus 100 does not include an LCD and/or a keypad.

Documents suitable for the direct printing function include PDF, TIFF, JPEG, XPS, and BMP files. In the case of the PDF file or the XPS file, as it is possible to encrypt the document when preparing the document by recording “Encrypt” information (for instance, a reference password) in a header or in the data of the document, the controller 120, which receives the PDF file or the XPS file, determines whether the document is the encrypted document based on the “Encrypt” information (reference password) contained in the document.

If the document input from the host 200 is an encrypted document, the controller 120 receives the password of the document from the host 200 and compares the password with the reference password of the document. If the password matches with the reference password, the controller 120 controls the printing unit 130 to print the document. In contrast, if the password does not match the reference password, the controller 120 controls the host 200 to display a message (such as on a user interface unit 230) describing the mismatch of the password.

In addition, the controller 120 provides a password input window through the host 200 in such a manner that the user can input the password and select a direct printing menu through the password input window displayed on the host 200 when printing the document.

The controller 120 counts display time of the password input window by using an internal timer in order to limit the time for inputting the password. If the password input window is displayed for a predetermined time (for instance, about 10 seconds), the controller 120 controls the host 200 to display a message informing the end of the password input time. This is for preventing password stealing and hacking.

Further, if the user erroneously inputs the password or does not input the password within the predetermined period of time, the controller 120 controls the host 200 to display a message inquiring whether the user wants to retry inputting of the password.

The printing unit 130 outputs the document after printing the document on a recording medium according to a control signal of the controller 120.

In addition, the host 200 that transmits the document to the image forming apparatus 100 according to aspects of the present invention includes a communication unit 210, a controller 220, and a user interface unit 230. The host 200 is connected to the image forming apparatus 100 through the communication unit 210.

The communication unit 210 is connected to the image forming apparatus 100, such as a printer, a scanner, a photocopier, a facsimile, or a multifunctional device, through a network in order to support the communication interface relative to the image forming apparatus 100. The communication unit 210 of the host 200 need not be hard-wired to the image forming apparatus 100; but instead, the host 200 may exchange data and information, securely or not, with the image forming apparatus 100 via IR, Wi-Fi, Bluetooth, or the like in addition to or instead of any wire connection. Further, the network between the image forming apparatus 100 and the host 200 may only include the image forming apparatus 100 and the host 200 or may include other hosts, computer terminals, or any other network element. Further, the user interface unit 230 need only be connected to the host 200 and need not be included in the host 200 as in the shown example.

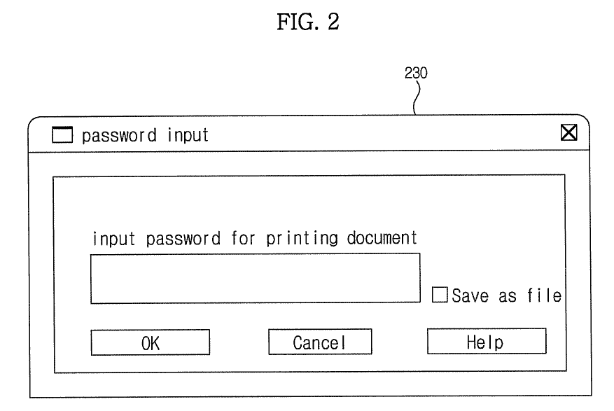

The controller 220 transmits the document to the image forming apparatus 100 through the communication unit 210. If the document is an encrypted document, a password input is requested by the image forming apparatus 100. Thus, the controller 220 provides a password input window, as shown in FIG. 2, to the host 200 in order to allow the user to input the password.

The user interface unit 230 may include an LCD and/or Kanda appears to disclose a user-operated video editing system through which a user manipulates video data. a keypad to transfer the user's command to the controller 220 and to display operation information according to the control signal of the controller 220. If the document is an encrypted document, the user interface unit 230 displays the password input window according to the control signal of the controller 220 in order to allow the user to input the password. Accordingly, the user can input the password through the password input window displayed on the user interface unit 230 and the password input by the user is transferred to the image forming apparatus 100 through the communication unit 210.

FIG. 2 is a view illustrating the password input window which allows the user to input the password according to aspects of the present invention. Referring to FIG. 2, if the password input window is displayed on the user interface unit 230, the user inputs the password and then pushes the OK button. Further, the user may cancel the printing operation by pressing the Cancel button, or the user may ask for instructions by pressing the Help button. Moreover, the user may choose to save the printing job as a file by selecting the Save as file checkbox.

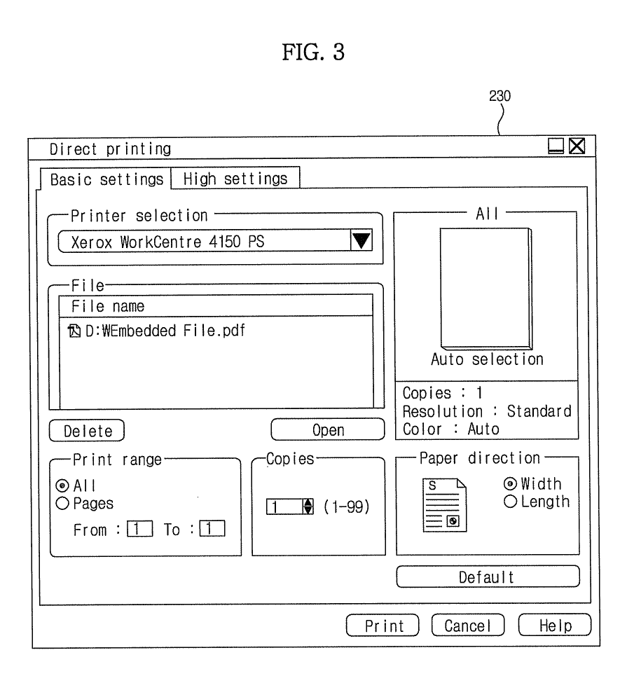

FIG. 3 is a view illustrating a printing window for printing document data according to aspects of the present invention. The printing window is for setting the direct printing menu for the document to print the document after the user has input the password through the password input window shown in FIG. 2. Referring to FIG. 3, if the printing window is displayed on the user interface 230, the user sets desired direct printing functions and then pushes the Print button. The direct printing functions include but are not limited to printer selection, file specification, open, delete, print range, number of copies to be printed, paper direction, cancel, help, and the like. While shown with different print options relating to pages to be printed, copies, paper direction, etc., it is understood that the printing window can be otherwise configured and/or integrated with the password window of FIG. 2.

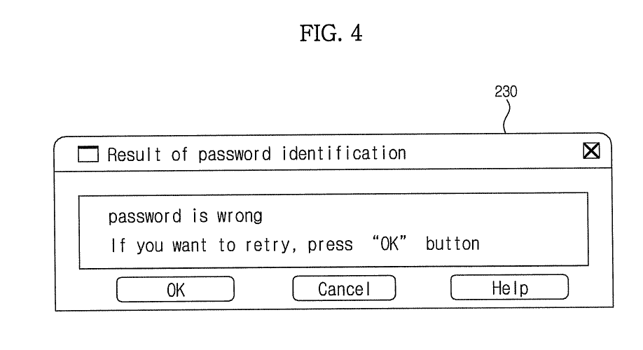

FIG. 4 is a view illustrating a window that displays a result of a password identification according to aspects of the present invention. If the password input in the password input window of FIG. 3 mismatches the reference password of the document, a message, which informs of the mismatch of the password and inquires whether the user wants to retry the input of the password, is displayed. In FIG. 4, as the window is displayed on the user interface unit 230, the user can input the password again. The user may input the password directly in the window of FIG. 4, although not shown, or the controller 120 of the image forming apparatus 100 may control the host 200 to display again the password input window of FIG. 3. Although the above-windows are illustrated as being displayed on a display, the controller 120 may request that the host 200 output an audio message indicating the request for the password, the incorrect input of the password, etc.

Hereinafter, the operation and the effect of the image forming apparatus 100 equipped with the direct printing function for printing an encrypted document and the procedure for outputting the document will be described.

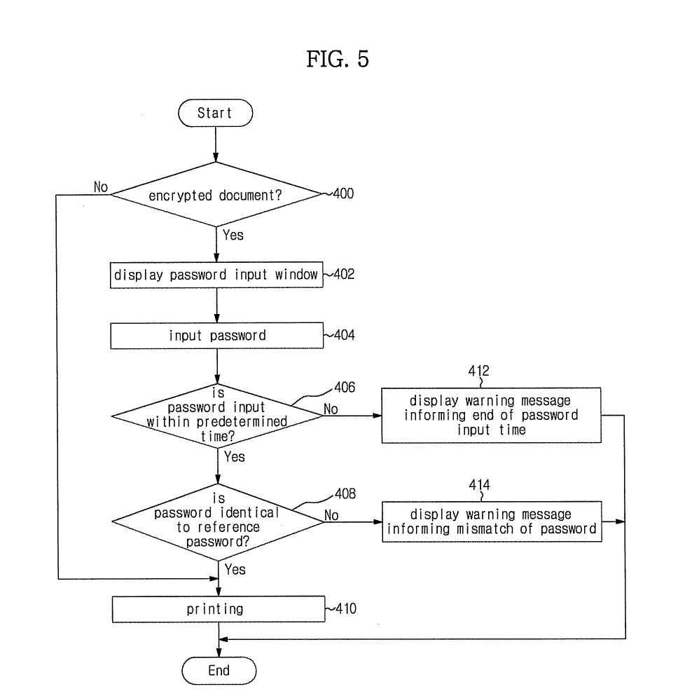

FIG. 5 is a flowchart illustrating the procedure for outputting the document using the image forming apparatus 100 according to an embodiment of the present invention. Referring to FIG. 5, the controller 120 of the image forming apparatus 100 receives the document from the host 200 through the communication unit 110, and determines whether the document is the encrypted document (400).

At this time, the encrypted document is determined based on the Encrypt information contained in the header section or in the data of the document. If the document has the Encrypt information (i.e., reference password) in the header section thereof, the document is determined to be an encrypted document. However, the encryption can be otherwise detected.

If it is determined in operation 400 that the document is an encrypted document, the controller 120 requests the host 200 to display the password input window of FIG. 2. Upon receiving the request from the controller 120, the controller 220 of the host 200 displays the password input window, as shown in FIG. 2, on the user interface unit 230 to allow the user to input the password (402). As the password input window is displayed on the user interface unit 230, the user inputs the password and then pushes the OK button (404).

While the password input window of FIG. 2 is displayed, the controller 120 of the image forming apparatus 100 counts the display time of the password input window by using the internal timer and determines whether the password is input within a predetermined time (for instance, about 10 seconds) (406).

If it is determined in operation 406 that the password is input within the predetermined time, the controller 120 of the image forming apparatus 100 receives the password from the host 200 through the communication unit 110 and compares the password with the reference password (408). If the input password is identical to the reference password, the document is printed by the printing unit 130 (410). The document may be printed by outputting the document on a display of a peripheral device, screen printing the document on a medium, or printing the input document data on a printable medium. The display of the host 200 may be the display of a computer. The medium for screen printing and the printable medium for printing can be any substrate that is screen printable or printable, respectively. Further, while described as requiring a password for each direct print, it is understood that the password could be locally stored or correspond to an image forming apparatus 100 login or host 200 and recalled when the encrypted data is to be output such that the screen of FIG. 2 need not be used in all aspects.

Before the document is printed by the printing unit 130 (that is, before the input password is compared with the reference password), the controller 120 of the image forming apparatus 100 requests the host 200 to display the printing window, as shown in FIG. 3, on the user interface unit 230 such that the user can set the direct printing menu. However, according to aspects of the invention, the printing window of FIG. 3 need not be displayed but the selectable settings therein may be predetermined. As the printing window is displayed on the user interface unit 230, the user sets the desired direct printing functions and then pushes the printing button such that the controller 120 can perform the procedures following operation 408.

Meanwhile, if it is determined in operation 400 that the document is not the encrypted document, the document is directly printed by the printing unit 130.

In addition, if it is determined in operation 406 that the user does not input the password within the predetermined time, the controller 120 of the image forming apparatus 100 requests the host 200 to display the message informing the end of the password input time on the user interface unit 230 (for instance, “the password input time ends”) (412), and stops the printing operation for the document.

In addition, if it is determined in operation 408 that the input password is not identical to the reference password, the controller 120 of the image forming apparatus 100 requests the host 200 to display the message informing the mismatch of the password on the user interface unit 230 (for instance, “the password is wrong”) (414), and stops the printing operation for the document. Further, when the user erroneously inputs the password or does not input the password within the predetermined time, the controller 120 of the image forming apparatus 100 requests the host 200 to display the window (i.e., FIG. 4) on the user interface unit 230 together with the messages in operations 412 and 414 in order to allow the user to retry the input of the password. As the window shown in FIG. 4 is displayed on the user interface unit 230, the user can input the password again. As such, if the user pushes the OK button, the controller 120 can perform the procedure following operation 402. However, aspects of the current invention are not limited thereto. For example, upon determination by the controller 120 that the password received from the host 200 is not identical to the reference password of the encrypted document, the controller 120 may request that the host 200 display to the user a notice that only a limited number of attempts to correctly enter the password associated with the encrypted document remain, and upon repeated failure to correctly enter the password, the controller 120 may lock or prevent the printing of the encrypted document for a time so as to increase security of the encrypted document data.

Meanwhile, although the present invention has been described in that the image forming apparatus 100 receives the document from the host 200, aspects of the present invention are not limited thereto. For instance, the image forming apparatus 100 can receive the document from an external storage medium or a memory card inserted into the image forming apparatus 100 without departing from the scope of the present invention.

As described above, according to the image forming apparatus and the method of outputting the document by using the same of the present invention, the encrypted document can be printed through the direct printing scheme so that convenience to the user can be significantly improved. While not required in all aspects, aspects of the invention can be implemented using computer software and/or hardware stored on a computer readable media for use on one or more computers and/or processors.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of outputting a document using an image forming apparatus having no user interface for inputting a password, the method comprising:
receiving a document subject to a direct printing and determining whether the received document is encrypted;
receiving a password from a host if the document is determined to be encrypted;
comparing at the image forming apparatus the received password to a reference password of the document and determining whether the password matches the reference password; and
performing a printing operation for the document according to the comparison of the received password and the reference password if the document is determined to be encrypted.

2. The method of claim 1, wherein the document comprises a PDF file or an XPS file.

3. The method of claim 1, wherein the document is an encrypted document input from the host or a portable storage medium.

4. The method of claim 1, wherein the receiving of the password from the host comprises:
determining whether the password is input within a predetermined time; and
displaying a warning message at the host if the password is not input within the predetermined time.

5. The method of claim 1, further comprising:
displaying a warning message at the host if the password is not identical to the reference password.

6. The method of claim 5, further comprising:
displaying a password input window at the host into which the password is re-entered after the warning message.

7. The method of claim 1, further comprising:
performing the printing operation for the document if the document is determined to be not encrypted.

8. The method of claim 1, wherein the receiving the password from the host comprises:
displaying a password input window on the host to receive the password.

9. The method of claim 8, further comprising:
determining a time for which the password input window is displayed;
comparing the determined time to a predetermined time; and
displaying a warning message at the host if the determined time is greater than the predetermined time.

10. The method of claim 1, further comprising:
displaying on the host a printing window in which direct printing settings are selectable.

11. An image forming apparatus having no user interface for inputting a password, the image forming apparatus comprising:
a printing unit to print a received document; and
a controller to receive the document subject to a direct printing, to determine whether the received document is an encrypted document, to receive a password from a host if the document is determined to be encrypted, to compare the received password with a reference password included in the document if the document is determined to be encrypted, and to control the printing unit to print the document when the password matches the reference password if the document is determined to be encrypted.

12. The image forming apparatus of claim 11, wherein the encrypted document comprises a PDF file or an XPS file.

13. The image forming apparatus of claim 11, wherein the controller requests the host to display a warning message when the password does not match the reference password.

14. The image forming apparatus of claim 11, wherein the controller counts an input time for the password and requests the host to display a warning message when the input time for the password is greater than a predetermined period of time.

15. The image forming apparatus of claim 11, further comprising:
a communication unit to receive the document from a communication unit of the host and to provide the document to the controller.

16. The image forming apparatus of claim 11, wherein the controller controls the printing unit to print the document if the document is determined to be not encrypted.

17. An image forming apparatus having no user interface for inputting a password and which supports a direct printing function, comprising:
a controller to output a message relating to an input password to a host and to receive the input password from the host when an input document received from the host is determined to be encrypted, and to compare the received input password and a reference password at the image forming apparatus to determine if the input password and the reference password are the same; and
a printing unit to output the input document if the input document is not encrypted and to output the input document determined to be encrypted if the controller determines the input password is the same as the reference password.

18. The image forming apparatus of claim 17, further comprising:
a communication unit to receive the document from a communication unit of the host and to provide the document to the controller.

19. The image forming apparatus of claim 17, wherein the input password must be entered within a time period after the message requests entry of the input password is provided.

20. The image forming apparatus of claim 19, wherein if the input password is not timely entered, the controller again provides the message requesting the entry of the input password.

21. The image forming apparatus of claim 17, wherein the controller provides the message via the host to indicate that the input password and the reference password do not match when the controller determines that the input password and the reference password are not the same.

22. The image forming apparatus of claim 21, wherein the message indicating that the input password and the reference password are not the same requests that the input password is re-entered

23. The image forming apparatus of claim 22, wherein the message indicating that the input password and the reference password are not the same requests that the input password be re-entered only twice within a time.
